(19) United States
(12) Patent Application Publication
(10) Pub. No.: US 2007/0132742 A1
(43) Pub. Date: Jun. 14, 2007

(54) Method and apparatus employing optical angle detectors adjacent an optical input area

(76) Inventors: Deng-Peng Chen, Singapore (SG); Wee-Sin Tan, Singapore (SG); Kuldeep Kumar Saxena, Singapore (SG); Pak Hong Yee, Singapore (SG); Rani Ramamoorthy Saravanan, Singapore (SG)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/298,350

(22) Filed: Dec. 8, 2005

(51) Int. Cl. G09G 5/00

(52) U.S. Cl. 345/175

(57) ABSTRACT

In one embodiment, each of a plurality of optical angle detectors has a plurality of light sensing elements and is positioned at a different location adjacent an optical input area. Each of a plurality of light-control devices is positioned between the optical input area and one of the optical angle detectors, to cause particular rays of light to be mapped to particular light sensing elements of a respective one of the optical angle detectors. The optical angle detectors are positioned to cause each coordinate in the optical input area to be within a field of view of at least two of the optical angle detectors. Other embodiments are also disclosed.

### BACKGROUND

Optical input areas, such as optical touch panels, have been applied to a variety of applications, including computers, measurement instruments and portable devices (e.g., personal digital assistants (PDAs) and mobile phones).

Conventionally, optical input areas are bounded by emitter/detector pairs, wherein the emitters are positioned around the edges of the optical input area, and wherein each of the detectors is positioned in line-of-sight communication with its corresponding emitter, across the optical input area from its corresponding emitter. The emitter/detector pairs are also positioned such that they form a plurality of light paths that intersect to delimit x-coordinates and y-coordinates of the optical input area. In use, and when the light paths are interrupted by means of a user's stylus or finger, a control system assesses which light paths are blocked, and thereby determines the coordinates of the user's interaction with the optical input area.

Various permutations and extensions of the above-described optical input area have been proposed, but all are based on light paths that define a Cartesian coordinate system (i.e., based on light paths that define (x, y) coordinates at their intersections).

### SUMMARY OF THE INVENTION

In one embodiment, apparatus comprises a plurality of optical angle detectors, each of which is positioned at a different location adjacent an optical input area. Each of a plurality of light-control devices is positioned between the optical input area and one of the optical angle detectors to cause particular rays of light to be mapped to particular portions of a respective one of the optical angle detectors. The optical angle detectors are positioned to cause each coordinate in the optical input area to be within a field of view of at least two of the optical angle detectors.

In another embodiment, apparatus comprises a plurality of optical angle detectors, each of which has a plurality of light sensing elements, and each of which is positioned at a different location adjacent an optical input area. Each of a plurality of light-control devices is positioned between the optical input area and one of the optical angle detectors to cause particular rays of light to be mapped to particular light sensing elements of a respective one of the optical angle detectors. The optical angle detectors are positioned to cause each coordinate in the optical input area to be within a field of view of at least two of the optical angle detectors.

In yet another embodiment, a method comprises 1) positioning a plurality of light-control devices at different locations adjacent an optical input area, and 2) positioning a plurality of optical angle detectors at positions adjacent the optical input area that cause the light-control devices to map particular rays of light to particular portions of respective ones of the optical angle detectors. The optical angle detectors are positioned to cause each coordinate in the optical input area to be within a field of view of at least two of the optical angle detectors.

Other embodiments are also disclosed.

### BRIEF DESCRIPTION OF THE DRAWINGS

Illustrative embodiments of the invention are illustrated in the drawings, in which:

FIG. 1 illustrates an exemplary method employing optical angle detectors adjacent an optical input area;

FIG. 2 illustrates first exemplary apparatus for implementing the method of FIG. 1 and/or other methods;

FIG. 3 illustrates second exemplary apparatus for implementing the method of FIG. 1 and/or other methods;

FIG. 4 illustrates how polar angles represented by signals received from the optical angle detectors shown in FIGS. 2 or 3 may be mapped to Cartesian coordinates; and

FIGS. 5-8 illustrate various placements of optical angle detectors and light sources adjacent an optical input area.

### DETAILED DESCRIPTION

In contrast to optical input areas employing emitter/detector pairs that produce signals representing Cartesian coordinates of interactions with the optical input area, the methods and apparatus disclosed herein employ optical angle detectors that produce signals representing polar angles of interactions with an optical input area.

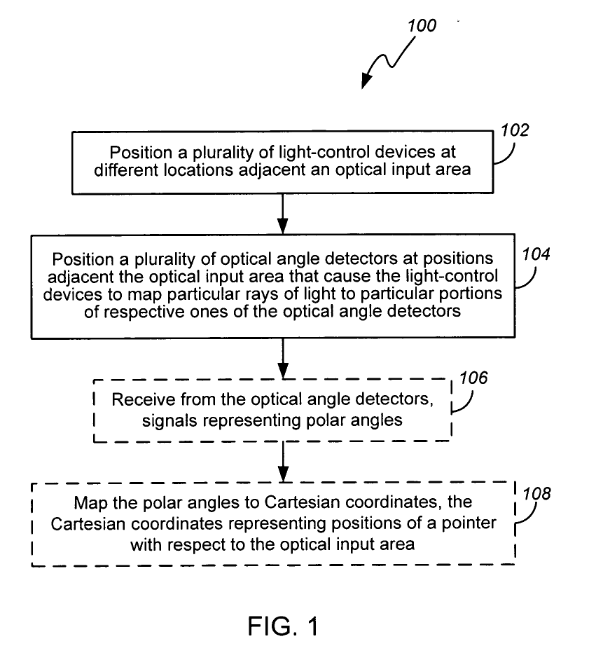

FIG. 1 illustrates an exemplary method 100 comprising 1) positioning 102 a plurality of light-control devices at different locations adjacent an optical input area, and 2) positioning 104 a plurality of optical angle detectors at positions adjacent the optical input area that cause the light-control devices to map particular rays of light to particular portions of respective ones of the optical angle detectors. The optical angle detectors are positioned to cause each coordinate in the optical input area to be within a field of view of at least two of the optical angle detectors. Signals representing polar angles may then be received 106 from the optical angle detectors; and the polar angles may be mapped 108 to Cartesian coordinates representing positions of a pointer with respect to the optical input area.

Of note, the actions 102, 104, 106, 108 of the method 100 may performed in alternate orders.

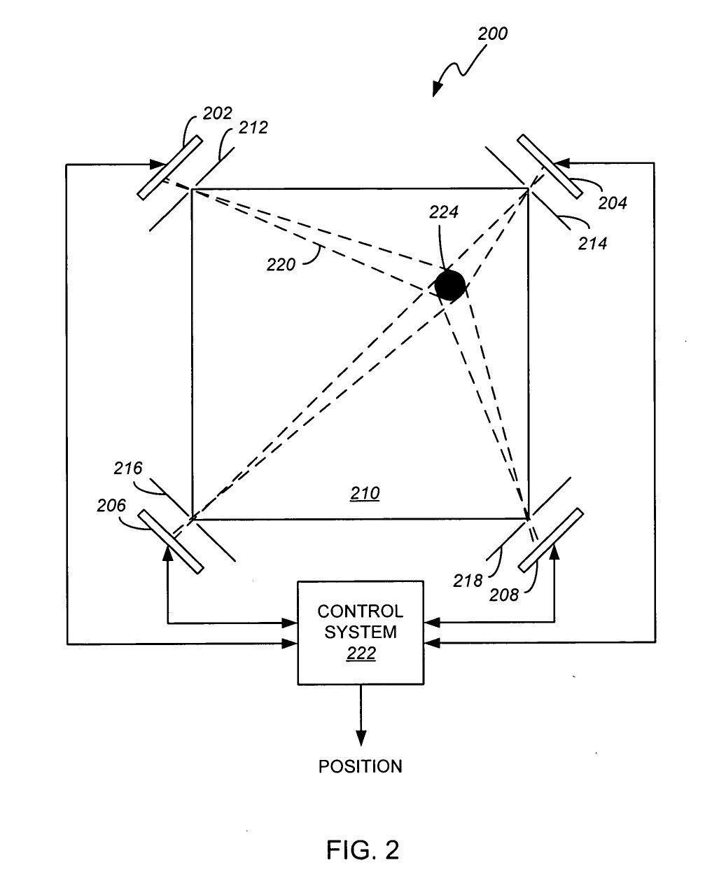

FIG. 2 illustrates first exemplary apparatus 200 for implementing the method 100 and/or other methods. The apparatus 200 comprises a plurality of optical angle detectors 202, 204, 206, 208, each of which is positioned at a different location adjacent an optical input area 210. By way of example, each of the optical angle detectors 202, 204, 206, 208 may be a complimentary metal-oxide semiconductor (CMOS) or charged-coupled device (CCD) having a plurality of light sensing elements (e.g., pixels). Although the detectors need only be one-dimensional (i.e., detectors having a single row of light sensing elements), the detectors could alternately be two-dimensional.

The apparatus 200 also comprises a plurality of light-control devices 212, 214, 216, 218, each of which is positioned between the optical input area 210 and one of the optical angle detectors 202, 204, 206, 208. The light-control devices 212, 214, 216, 218 cause particular rays of light, such as light ray 220, to be mapped to particular portions (i.e., to particular light sensing elements) of the optical angle detectors 202, 204, 206, 208. In FIG. 2, the light-control devices 212, 214, 216, 218 are shown to be pinholes that substantially limit the light rays incident on each of the detectors 202, 204, 206, 208 to one ray for each particular viewing angle (e.g., substantially one light ray for each viewing angle of the detector, from 0°-90°).

The optical angle detectors 202, 204, 206, 208 are positioned to cause each coordinate in the optical input area 210 to be within a field of view of at least two of the optical angle detectors 202, 204, 206, 208. A control system 222 may then be coupled to the detectors 202, 204, 206, 208 to 1) receive signals representing polar angles from the optical angle detectors 202, 204, 206, 208, and 2) map the polar angles to Cartesian coordinates representing positions of a pointer 224 with respect to the optical input area 210.

The control system 222 may be implemented in various ways, including by means of one or more of: a programmed circuit (e.g., a field-programmable gate array (FPGA) or application-specific integrated circuit (ASIC)), or a circuit (e.g., a microprocessor) controlled by firmware or software.

In one embodiment, the control system 222 may activate each of the optical angle detectors in series, and on a rotating basis (e.g., via a multiplexer). In this manner, a read buffer or other read logic may be shared by the detectors 202, 204, 206, 208.

Although FIG. 2 illustrates a system that uses four optical angle detectors 202, 204, 206, 208, it is noted that the control system 222 could also determine the position of the pointer 224 using any two of the optical angle detectors (although using more detectors provides better resolution). If a system is only provided with two detectors, it is preferable that they be positioned at two opposite corners of the optical input area, although other positions would work.

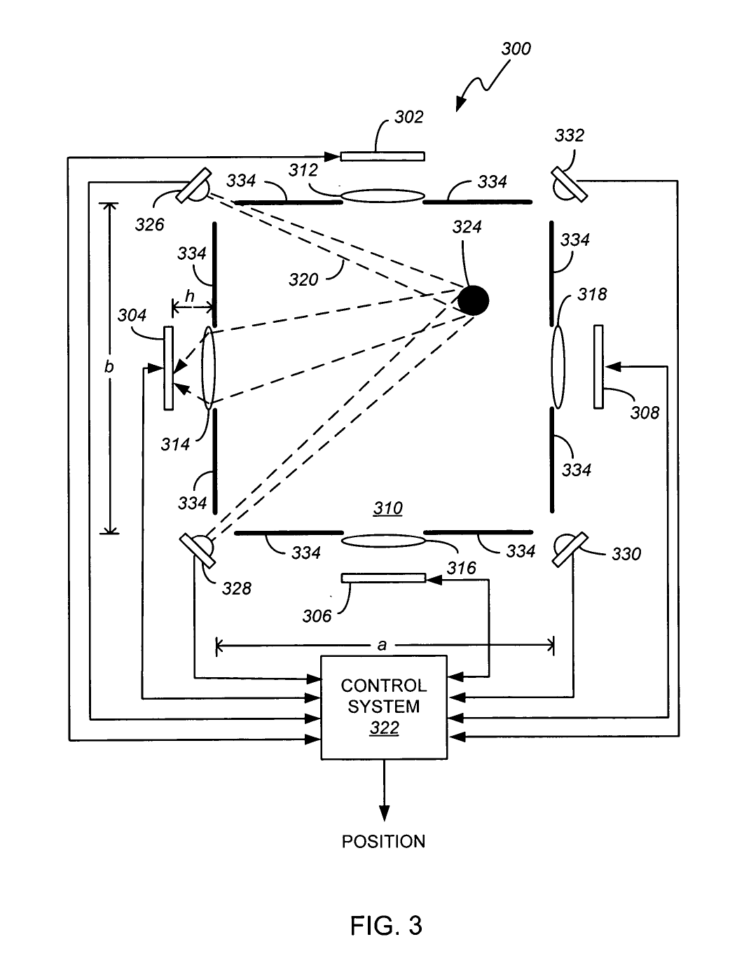

FIG. 3 illustrates second exemplary apparatus 300 for implementing the method 100 and/or other methods. The apparatus 300 comprises a plurality of optical angle detectors 302, 304, 306, 308, each of which is positioned at a different location adjacent an optical input area 310. By way of example, each of the optical angle detectors 302, 304, 306, 308 may be a position-sensitive detector.

The apparatus 300 also comprises a plurality of light-control devices 312, 314, 316, 318, each of which is positioned between the optical input area 310 and one of the optical angle detectors 302, 304, 306, 308. The light-control devices 312, 314, 316, 318 cause particular rays of light, such as light ray 320, to be mapped to particular portions of the optical angle detectors 302, 304, 306, 308. In FIG. 3, the light-control devices 312, 314, 316, 318 are shown to be light-focusing lenses, each of which focuses the light rays reflected from a pointer 324 into one or more spots on the detectors 302, 304, 306, 308.

The apparatus 300 further comprises a number of light sources 326, 328, 330, 332 (e.g., light emitting diodes (LEDs), each of which is positioned adjacent the optical input area 310.

The optical angle detectors 302, 304, 306, 308 are positioned to cause each coordinate in the optical input area 310 to be within a field of view of at least two of the optical angle detectors 302, 304, 306, 308. A control system 322 may then be coupled to the detectors 302, 304, 306, 308 to 1) receive signals representing polar angles from the optical angle detectors 302, 304, 306, 308, and 2 ) map the polar angles to Cartesian coordinates representing positions of a pointer 324 with respect to the optical input area 310.

The control system 322 may activate each of the optical angle detectors 302, 304, 306, 308 in series, and on a rotating basis (e.g., via a multiplexer). In this manner, a read buffer or other read logic may be shared by the detectors 302, 304, 306, 308. The control system 322 may also activate each of the optical angle detectors 302, 304, 306, 308 in sync with at least one of the light source(s) 326, 328, 330, 332 that is adjacent the optical angle detector. For example, and as illustrated in FIG. 3, the control system 324 may activate the optical angle detector 304 in sync with light sources 326, 328 adjacent either side of the detector 304. Light rays generated by the light sources 326, 328, such as light ray 320, then 1) reflect from the pointer 322, 2) are received by the lens 314, and 3) are focused into one or more spots on the surface of the detector 304. The control system 324 could then deactivate the detector 304 and light source 326, and activate the detector 306 in sync with light sources 328 and 330. In this manner, each of the optical angle detectors 302, 304, 306, 308 is provided an opportunity to “see” the pointer 322 and produce a signal that represents a polar angle at which the pointer 322 is positioned with respect to the detector.

To reduce the power consumption of the light sources 326, 328, 330, 332, light sources that need to be activated simultaneously (such as light sources 326, 328 in the context of detector 304) may be connected in series, within a switching matrix that provides for selecting the ones of the light sources 326, 328, 330, 332 that are connected in series.

The control system 322 may be implemented in various ways, including by means of one or more of: a programmed circuit (e.g., a field-programmable gate array (FPGA) or application-specific integrated circuit (ASIC)), or a circuit (e.g., a microprocessor) controlled by firmware or software.

In one embodiment, the light sources 326, 328, 330, 332 emit light of a predetermined wavelength, such as infrared (IR) light, and the light-control devices 312, 314, 316, 318 comprise filters to pass only the predetermined wavelength of light. If the apparatus 300 is used in an environment with a lot of ambient light (i.e., light other than that which is reflected from the pointer 322), the ambient light can thereby be filtered out, and prevented from blurring the spot formed on a detector, by virtue of light reflecting off the pointer 322.

Another way to factor out the effects of ambient light is to modulate the light produced by the light sources 326, 328, 330, 332. In this manner, readings with and without light that is produced by the light sources 326, 328, 330, 332, and reflected from the pointer 334, may be compared to factor out the effects of ambient light. Light source modulation also helps to reduce power consumption of the apparatus 300.

The apparatus 300 may further comprise a light-absorbing frame 334 that bounds the optical input area 310. The frame 334 may be provided with openings that allow light to pass from the optical input area 310 to the lenses 312, 314, 316, 318. Alternately, the lenses 312, 314, 316, 318 may be replaced with other light-control devices, such as pinholes in the frame 334 that substantially limit the light rays incident on each of the detectors 302, 304, 306, 308 to one ray for each particular viewing angle (e.g., substantially one light ray for each viewing angle of the detector, from 0°-90°).

To improve the resolution of the apparatus 300, the focal point of each lens 312, 314, 316, 318 should be positioned such that the lens is optimized to image pointers 322 that are positioned on a half of the optical input area 310 that is opposite the side of the optical input area 310 where the lens 312, 314, 316, 318 is positioned. Even more preferably, the focal points of the lenses 312, 314, 316, 318 should enable the lenses to optimally view pointers 322 that are about 75% of the way across optical input area 310. A suitable formula for calculating such a focal point is:

$$\frac{1}{h} + \frac{1}{\frac{3}{4} a ( b )} = \frac{1}{f} \qquad ( 1 )$$

where h is the distance between a detector and its corresponding lens; a and b are the width and length of the optical input area 310; and f is the focal length.

The focal point of each lens 312, 314, 316, 318 with respect to its corresponding detector 302, 304, 306, 308 is not critical, because a polar angle of the pointer 322 with respect to one of the detectors 302, 304, 306, 308 may be determined by means of the “center of gravity” of a light spot on the detector. The focal point need only be adjusted to ensure that positions of the pointer 322 with respect to the optical input area 310 do not cause a light spot to be directed outside the bounds of one or more of the detectors 302, 304, 306, 308.

If each optical angle detector 302, 304, 306, 308 is designed to image pointers 322 in the opposite half-plane of the optical input area 310, then the minimum length of a one-dimensional optical angle detector 302, 304, 306, 308 can be calculated as:
2ah/b (for detectors 302 and 306); and (2)
2bh/a (for detectors 304 and 308). (3)

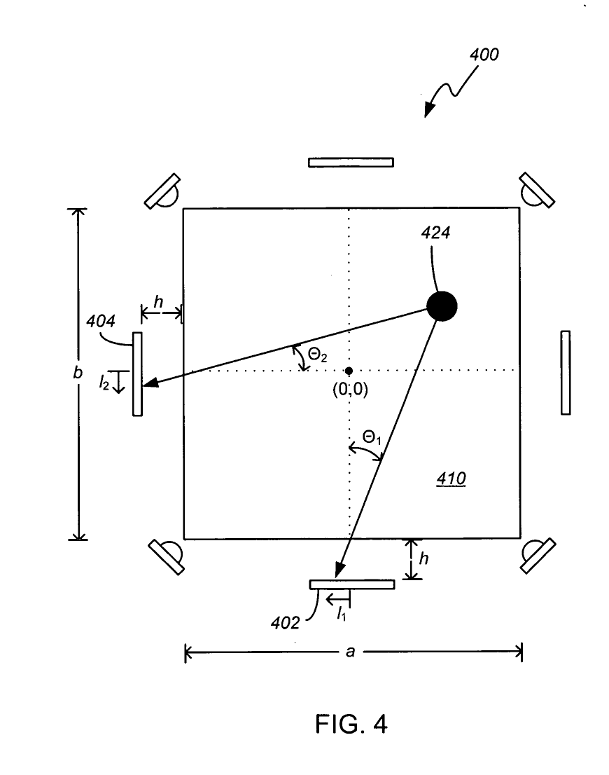

The equations set forth below, and FIG. 4, illustrate how the polar angles represented by the signals received from the optical angle detectors (e.g., the detectors shown in FIGS. 2 or 3) may be mapped to Cartesian coordinates. Note that in each of FIGS. 4-8, various of the apparatus' components, such as light-control devices and a control system, are not shown. However, their existence and position can be easily inferred from their representative positions in FIGS. 2 & 3.

In FIG. 4, the optical input area 410 has a width a and a length b, and each of the optical angle detectors 402, 404 is positioned at a distance h from the optical input area 410. The center of the optical input area 410 is assigned Cartesian coordinate (0,0), and a pointer 424 is positioned 1) at an angle Θ₁ with respect to an optical angle detector 402, and 2) at an angle Θ₂ with respect to an optical angle detector 404. The angles are detected by the detectors 402, 404 as light spots having centers of gravity l₁ and l₂.

The angles Θ₁ and Θ₂ have the following relation to the Cartesian position (x,y) of the pointer 424:

$$\begin{matrix}tg ( {Θ}_{1} ) = \frac{x}{y + \frac{b}{2}} = \frac{{l}_{1}}{- h} ( where tg is a tangent function ) ; and & ( 4 ) \\ tg ( {Θ}_{2} ) = \frac{- y}{x + \frac{a}{2}} = \frac{{l}_{2}}{- h} . & ( 5 )\end{matrix}$$

From the above equations, the following relationships may be derived between the positions l₁ and l₂, and the Cartesian position (x,y) of the pointer 424:

$$\begin{matrix}x = \frac{- {l}_{1}}{2} \frac{bh + {al}_{2}}{{l}_{1} {l}_{2} + {h}^{2}} & ( 6 ) \\ y = \frac{{l}_{2}}{2} \frac{ah - {bl}_{1}}{{l}_{1} {l}_{2} + {h}^{2}} & ( 7 ) \\ {l}_{1} = \frac{- hx}{y + \frac{b}{2}} & ( 8 ) \\ {l}_{2} = \frac{hy}{x + \frac{a}{2}} & ( 9 )\end{matrix}$$

Of note, the above equations can be implemented by the control system 222 or 322 without any need to implement complicated trigonometric functions.

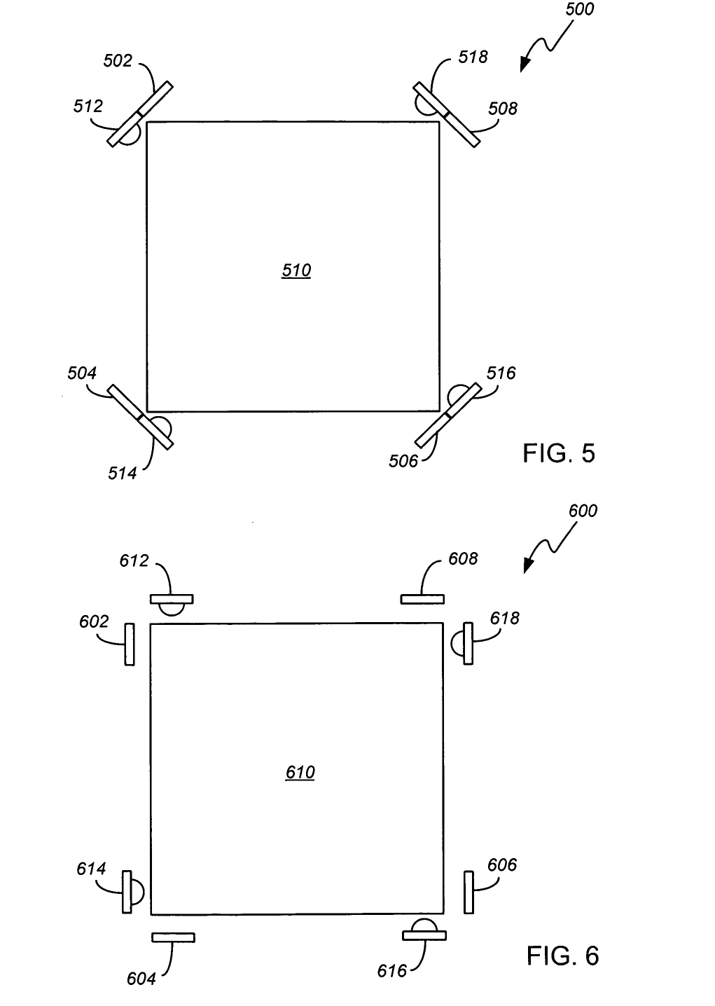

In FIG. 3, the optical input area 310 is rectangular, the optical angle detectors 302, 304, 306, 308 are positioned adjacent the edges of the optical input area 310, and the light sources 326, 328, 330, 332 are positioned at the corners of the optical input area 310. However, the detectors 302, 304, 306, 308 and light sources 326, 328, 330, 332 could alternately be arranged in other ways. For example, in FIG. 5, detectors 502, 504, 506, 508 and light sources 512, 514, 516, 518 are positioned in adjacent pairs at the corners of an optical input area 510.

FIG. 6 illustrates an arrangement similar to that shown in FIG. 5, wherein the detectors 602, 604, 606, 608 and light sources 612, 614, 616, 618 are still positioned at the corners of an optical input area 610, but are positioned parallel to the edges of the optical input area 610.

In FIG. 7, detectors 702, 704, 706, 708 and light sources 712, 714, 716, 718, 720, 722, 724, 726 are also positioned at the corners of an optical input area 710, but each detector is bounded on opposite sides by two light sources.

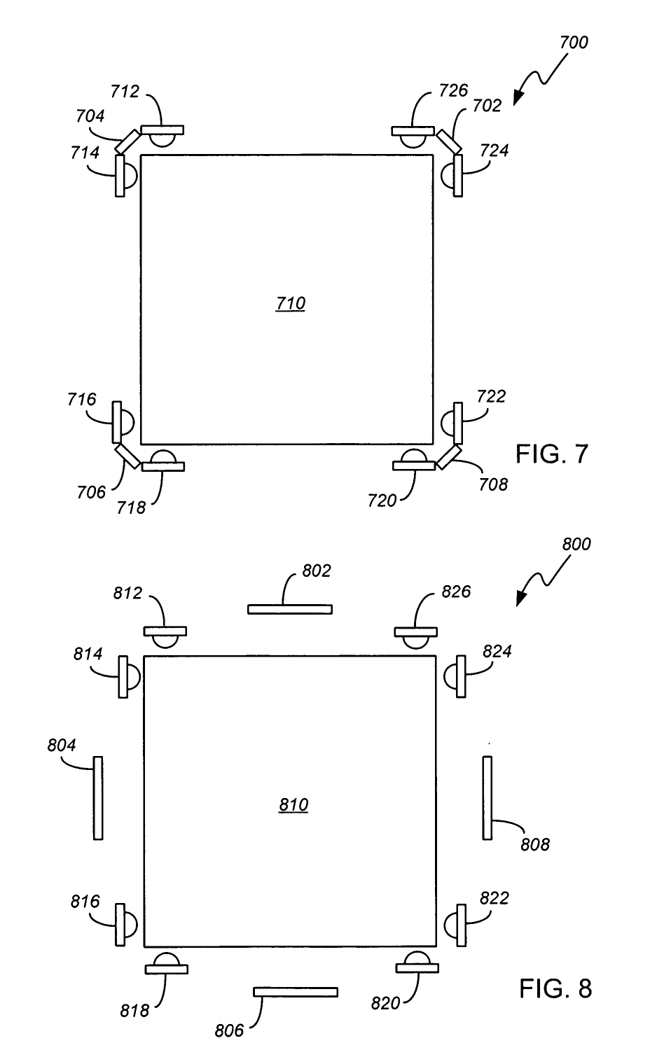

In FIG. 8, detectors 802, 804, 806, 808 are positioned at the edges of an optical input area 810, similarly to the detectors shown in FIG. 3. However, a pair of light sources 812/814, 816/818, 820/822, 824/826 is positioned at each corner of the optical input area 810, with one light source of each pair being aligned parallel to a different edge of the optical input area 810.

Depending on their configurations, the method 100 and apparatus 200, 300, 500, 600, 700, 800 disclosed herein can provide a solution that requires fewer computations by the control system; a lower component count over conventional optical input areas; flexibility in terms of the size of an optical input area that can be defined (e.g., no more components are required for larger optical input areas—the spacing of the components simply needs to be adjusted, and the control system has to be provided with new component spacing and/or a program that contemplates same)

What is claimed is:

1. Apparatus, comprising:
a plurality of optical angle detectors, each of which is positioned at a different location adjacent an optical input area; and
a plurality of light-control devices, each of which is positioned between the optical input area and one of the optical angle detectors to cause particular rays of light to be mapped to particular portions of a respective one of the optical angle detectors;
wherein the optical angle detectors are positioned to cause each coordinate in the optical input area to be within a field of view of at least two of the optical angle detectors.

2. The apparatus of claim 1, further comprising a control system to i) receive signals representing polar angles from the optical angle detectors, and ii) map the polar angles to Cartesian coordinates representing positions of a pointer with respect to the optical input area.

3. The apparatus of claim 2, wherein the control system comprises a programmed circuit.

4. The apparatus of claim 2, wherein the control system comprises a circuit controlled by software.

5. The apparatus of claim 1, further comprising a control system to activate each of the optical angle detectors in series, and on a rotating basis.

6. The apparatus of claim 1, wherein each of the light-control devices has a focal point that optimizes the light-control device to image pointers positioned on a half of the optical input area opposite a side of the optical input area where the light-control device is positioned.

7. The apparatus of claim 1, wherein the optical angle detectors comprise at least one position-sensitive detector.

8. The apparatus of claim 1, wherein the plurality of optical angle detectors are positioned at two opposite corners of the optical input area.

9. The apparatus of claim 1, wherein the optical input area is rectangular, and wherein the plurality of optical angle detectors are positioned at four corners of the optical input area.

10. The apparatus of claim 1, further comprising a number of light sources, each of which is positioned adjacent the optical input area.

11. The apparatus of claim 10, further comprising a control system to activate each of the optical angle detectors in sync with at least one of the light source(s) that is adjacent the optical angle detector, wherein the optical angle detectors are activated in series, and on a rotating basis.

12. The apparatus of claim 11, wherein each of the optical angle detectors is activated in sync with at least two of the light sources that are adjacent either side of the optical angle detector.

13. The apparatus of claim 10, wherein the light source(s) comprise at least one light emitting diode (LED).

14. The apparatus of claim 10, wherein at least two of the optical angle detectors i) are positioned at corners of the optical input area, and ii) are positioned adjacent respective ones of the light sources.

15. The apparatus of claim 10, wherein at least two of the optical angle detectors i) are positioned at corners of the optical input area, and ii) are bounded on opposite sides by ones of the light sources.

16. The apparatus of claim 10, wherein the optical input area is rectangular, wherein the light sources are positioned at four corners of the optical input area, and wherein the optical angle detectors are positioned at four sides of the optical input area.

17. The apparatus of claim 10, wherein the light source(s) emit light of a predetermined wavelength, and where the light-control devices comprise filters to pass only the predetermined wavelength of light.

18. The apparatus of claim 1, wherein the light-control devices comprise at least one light-focusing lens.

19. The apparatus of claim 1, further comprising a light-absorbing frame bounding the optical input area, wherein the frame allows light to pass from the optical input area to the optical angle detectors through the light-control devices.

20. The apparatus of claim 19, wherein the light-control devices comprise at least one pinhole formed in the light-absorbing frame.

21. Apparatus, comprising:
a plurality of optical angle detectors, each of which has a plurality of light sensing elements, and each of which is positioned at a different location adjacent an optical input area; and
a plurality of light-control devices, each of which is positioned between the optical input area and one of the optical angle detectors to cause particular rays of light to be mapped to particular light sensing elements of a respective one of the optical angle detectors;
wherein the optical angle detectors are positioned to cause each coordinate in the optical input area to be within a field of view of at least two of the optical angle detectors.

22. The apparatus of claim 21, wherein the optical angle detectors comprise at least one charge-coupled device (CCD).

23. The apparatus of claim 21, wherein the optical angle detectors comprise at least one complimentary metal-oxide semiconductor (CMOS).

24. A method, comprising:
positioning a plurality of light-control devices at different locations adjacent an optical input area; and
positioning a plurality of optical angle detectors at positions adjacent the optical input area that cause the light-control devices to map particular rays of light to particular portions of respective ones of the optical angle detectors;
wherein the optical angle detectors are positioned to cause each coordinate in the optical input area to be within a field of view of at least two of the optical angle detectors.

25. The method of claim 24, further comprising:
receiving from the optical angle detectors, signals representing polar angles; and
mapping the polar angles to Cartesian coordinates, the Cartesian coordinates representing positions of a pointer with respect to the optical input area.

26. The method of claim 24, further comprising, positioning a number of light sources adjacent the optical input area.

27. The method of claim 26, further comprising:
activating each of the optical angle detectors in sync with at least one of the light sources that is adjacent the optical angle detector; and
activating the optical angle detectors in series, and on a rotating basis.
